(19) United States
(12) Patent Application Publication
(10) Pub. No.: US 2017/0367364 A1
(43) Pub. Date: Dec. 28, 2017

(54) METHODS OF PREVENTING AND TREATING BRONCHOPULMONARY DYSPLASIA USING HIGH FAT HUMAN MILK PRODUCTS

(71) Applicant: Prolacta Bioscience. Inc., City of Industry, CA (US)

(72) Inventors: Martin LEE, City of Industry, CA (US); Scott ELSTER, City of Industry, CA (US); Joseph FOURNELL, City of Industry, CA (US)

(21) Appl. No.: 15/540,937

(22) PCT Filed: Dec. 30, 2015
(86) PCT No.: PCT/US15/68050

§ 371 Date: Jun. 29, 2017

Related U.S. Application Data
(60) Provisional application No. 62/098,151, filed on Dec. 30, 2014.

(51) Int. Cl. A23C 13/14; A23C 9/152; A23L 2/52; A23L 33/10; A23C 9/20; A23L 33/00

(52) U.S. Cl. CPC A23C 13/14; A23C 9/206; A23L 33/40; A23L 2/52; A23L 33/10; A23C 9/152; A23V 2002/00; A23V 2200/314

(57) ABSTRACT

The disclosure features a human milk cream composition, standardized high fat human milk formulations as well as methods of making and using such compositions. In particular, the disclosure features a method of using a human milk cream composition and/or standardized high fat human milk formulations to treat infants with bronchopulmonary dysplasia (BPD) or at risk of developing BPD.

### CROSS REFERENCE TO RELATED APPLICATIONS

This application claims priority to U.S. Provisional Patent Application No. 62/098,151, filed Dec. 30, 2014, the contents of which is hereby incorporated by reference in its entirety.

### FIELD OF THE INVENTION

The present disclosure relates generally to high fat human milk products, such as standardized human cream compositions, methods of producing the compositions, and methods of using the compositions.

### BACKGROUND OF THE INVENTION

Human milk is the ideal source of nutrition for premature infants, providing benefits in host defense, gastrointestinal maturation, infection rate, neurodevelopmental outcomes, and long-term cardiovascular and metabolic disease (Schanler, R. J., Outcomes of human milk-fed premature infants. Semin Perinatol, 2011. 35(1): p. 29-33). An exclusive human milk (HM)-based diet significantly decreases the rates of necrotizing enterocolitis (NEC), sepsis, days of parenteral nutrition, and death (Sullivan, S., et al., An exclusively human milk-based diet is associated with a lower rate of necrotizing enterocolitis than a diet of human milk and bovine milk-based products. J Pediatr, 2010. 156(4): p. 562-567.e1; Cristofalo, E. A., et al., Randomized trial of exclusive human milk versus preterm formula diets in extremely premature infants. The Journal of Pediatrics, 2013(163): p. 1592-1595; Abrams, S. A., et al., Greater Mortality and Morbidity in Extremely Preterm Infants Fed a Diet Containing Cow Milk Protein Products. Breastfeeding Medicine, 2014. 9(6): p. 281-285). The American Academy of Pediatrics recommends that mother's own milk or donor human milk should be used as the foundation of enteral feeds for all very low birth weight (VLBW) infants (<1250 g) (Breastfeeding, A.A.o.P.S.o., Breastfeeding and the use of human milk. Pediatrics, 2012. 129(3): p. e827-e841). An exclusive HM-based diet for these infants includes mother's own milk, donor HM and pasteurized donor HM-derived fortifier (Prolact+H²MF, Prolacta Bioscience, Industry, CA).

Bronchopulmonary dysplasia (BPD) is a disease that predominantly affects premature infants and can lead to growth failure and death. Multiple factors are involved in the pathophysiology of BPD, including toxic oxygen levels, ventilator-induced lung injury and release of inflammatory cytokines and cytotoxic enzymes such as proteases and elastases. Injury in early development of the lungs leads to arrest of alveolar and vascular growth, resulting in fewer, larger alveoli and fewer capillaries. Therapies to combat BPD include pharmacological treatments, lung protective ventilator strategies and nutritional interventions. Yet strategies to alleviate BPD may also create unwanted side effects. Pharmacological treatments such as oxygen, diuretics, bronchodilators and steroids may only give transient benefit and have unacceptable consequences that include longer hospital stay, electrolyte imbalance, tachycardia and hyperglycemia (Baveja, R. and Christou, H. Pharmacological Strategies in the Prevention and Management of Bronchopulmonary Dysplasia. Seminars in Perinatology, 2006. 30:209-218).

Growth failure in infants with BPD is predominantly due to malnutrition since these infants often experience disruptions in their feeding regimens during pulmonary exacerbations (Biniwale, M. A. and R. A. Ehrenkranz, The Role of Nutrition in the Prevention and Management of Bronchopulmonary Dysplasia. Seminars in Perinatology, 2006. 30(4): p. 200-208). They also experience increased energy expenditure to facilitate their work of breathing, support their amplified metabolic rate, and generate new tissue while maintaining thermoregulation and physical activity (Theile, A., et al., Nutritional Strategies and Growth in Extremely Low Birth Weight Infants with Bronchopulmonary Dysplasia Over the Past 10 years. Journal of Perinatology, 2012. 32: p. 117-122). Infants developing BPD, therefore, may require 20 to 40% more calories than their aged matched controls. Thus, providing optimal nutrition is essential as part of an effective therapy for the BPD population.

Unfortified human milk does not meet the nutritional needs of low birth weight (LBW) or very low birth weight (VLBW) infants particularly those with BPD or at risk of developing BPD. Recent data has shown that the energy content of human milk often falls below generally accepted value of 20 kcal/oz (Wojcik, K. Y., et al., Macronutrient analysis of a nationwide sample of donor breast milk. Journal of the American Dietetic Association, 2009. 109(1): p. 137-140; Vieira, A. A., et al., Analysis of the influence of pasteurization, freezing/thawing, and offer processes on human milk's macronutrient concentrations. Early Human Development, 2011. 87(8): p. 577-580). As a result, the expected energy and nutrient content is not achieved a significant percentage of the time. Due to the increased energy and macronutrient requirements of the BPD infant population compared to the general VLBW infant population, the ability to provide the extra calories for BPD infants would be an important step toward therapeutic intervention in the management of this lung disease.

Previous efforts to increase the caloric content of human milk have focused on increased protein content (See e.g. U.S. Pat. No. 8,545,920, incorporated by reference herein in its entirety), however, increasing caloric content through protein concentration is an expensive and time consuming process. Thus, there is a need for human milk formulations with increased caloric concentration without having to go through the time and expense to purify and concentrate large amounts of human milk proteins.

Further, fluid restriction is especially important in the management of VLBW infants due to their predisposition to developing pulmonary edema (See e.g. Binwale and Ehrenkranz (2006) Semin Perinatol., 30:200-9). It has been postulated that higher fluid intake inhibits the process of extracellular fluid contraction after birth resulting in decreased lung compliance and need for more ventilator support that may damage the lung tissue and cause disease (Oh, et al. J. Pediatr., 147:786-90). As such, greater fluid intake and less weight loss in the first ten days of life have been demonstrated to increase an infant's risk of developing BPD. (Wemhonor, et al., 2011) BMC Pulmonary Medicine, 11:7)

Thus, a cost-effective solution is needed to solve the problem of malnutrition in VLBW infants in order to prevent and/or reduce the incidence/severity of BPD while avoiding the unwanted negative effects associated with increased fluid intake.

### SUMMARY OF THE INVENTION

The current invention solves the problem by providing pasteurized, high fat human milk products that can be administered enterally and increase the caloric content of human milk while not substantially increasing the overall volume fed to the VLBW infant with BPD or at risk of developing BPD. The current invention allows for infants, particularly LBW and VLBW infants with BPD or at risk of developing BPD to have improved clinical outcomes such as, increased growth metrics, a decrease in the incidence and/or severity of BPD, decreased length of stay (LOS) in the hospital and earlier post menstrual age at discharge.

In one aspect, the disclosure features a method for improving one or more clinical outcomes in an infant with bronchopulmonary dysplasia (BPD) or at risk of developing BPD, comprising administering to said infant a human milk composition or infant formula fortified with a pasteurized human milk cream composition, wherein the cream composition comprises about 2.0 kcal/ml to about 3.0 kcal/ml. In one embodiment, the cream composition comprises about 2.5 kcal/ml. In one embodiment, the cream composition comprises about 25% fat. In another embodiment, the cream composition comprises human skim milk permeate. In yet another embodiment, the cream composition comprises deionized water. In one embodiment, the method for improving one or more clinical outcomes in an infant with BPD or at risk of developing BPD further comprises administering the fortified human milk composition enterally.

In one embodiment, the human milk composition fortified with a pasteurized human cream composition is derived from the infant's own mother. In another embodiment, the human milk composition to be fortified is donor milk. In another embodiment, the human milk composition to be fortified is a ready to feed standardized human milk formulation. In one embodiment, the ready to feed standardized human milk formulation is Prolact HM™ or PremieLact™. In still another embodiment the human milk composition to be fortified with the pasteurized human cream formulation is also fortified with a protein-containing fortifier. In one embodiment, the high protein fortifier is Prolact⁺™ human milk fortifier.

In one embodiment, the human milk composition fortified with a pasteurized human cream composition results in a mixed composition comprising about 30 to about 40 Cal/oz. In one embodiment, the mixed human milk composition comprises about 32 Cal/oz. In another embodiment, the mixed human milk composition comprises about 38 Cal/oz. In one embodiment the mixed human milk composition comprises about 32 Cal/oz and has a protein to energy (PE) ratio of about 2.16 g protein/100 kcal. In one embodiment, the 32 Cal/oz mixed human milk composition with a PE ratio of about 2.16 g/100 kcal comprises about 23 mg/mL protein, 80 mg/mL of carbohydrates and 74 mg/mL of fat. In one embodiment, the mixed human milk composition comprises about 32 Cal/oz and has a PE ratio of about 2.8 g/100 kcal. In one embodiment, the 32 Cal/oz mixed human milk composition with a PE ratio of about 2.8 g/100 kcal comprises about 30 mg/mL protein, 80 mg/mL carbohydrate and about 71 mg/mL of fat. In one embodiment the mixed human milk composition comprises about 38 Cal/oz and has a PE ratio of about 1.8 g/100 kcal. In one embodiment, the mixed human milk composition comprising 38 Cal/oz and a PE ratio of about 1.8 g/100 kcal comprises about 23 mg/mL protein, 80 mg/mL of carbohydrates and about 97 mg/mL of fat. In one embodiment, the mixed human milk composition comprising 38 Cal/oz has a PE ratio of about 2.3 g/100 kcal. In one embodiment, the mixed human milk composition comprising 38 Cal/oz with a PE ratio of about 2.3 g/100 kcal comprises about 30 mg/mL of protein, 80 mg/mL of carbohydrates and about 94 mg/mL of fat.

In one aspect, the human milk composition may be formulated as a ready to feed standardized high fat human milk composition that comprises about 30 to about 40 Cal/oz. In one embodiment, the human milk composition comprises about 32 Cal/oz. In another embodiment, the standardized high fat human milk composition comprises about 38 Cal/oz. In one embodiment the standardized high fat human milk composition comprises about 32 Cal/oz and has a protein to energy (PE) ratio of about 2.16 g protein/100 kcal. In one embodiment, the 32 Cal/oz the standardized high fat human milk composition with a PE ratio of about 2.16 g/100 kcal comprises about 23 mg/mL protein, 80 mg/mL of carbohydrates and 74 mg/mL of fat. In one embodiment, the standardized high fat human milk composition comprises about 32 Cal/oz and has a PE ratio of about 2.8 g/100 kcal. In one embodiment, the 32 Cal/oz standardized high fat human milk composition with a PE ratio of about 2.8 g/100 kcal comprises about 30 mg/mL protein, 80 mg/mL carbohydrate and about 71 mg/mL of fat. In one embodiment, the standardized high fat human milk composition comprises about 38 Cal/oz and has a PE ratio of about 1.8 g/100 kcal. In one embodiment, the standardized high fat human milk composition comprising 38 Cal/oz and a PE ratio of about 1.8 g/100 kcal comprises about 23 mg/mL protein, 80 mg/mL of carbohydrates and about 97 mg/mL of fat. In one embodiment, the standardized high fat human milk composition comprising 38 Cal/oz has a PE ratio of about 2.3 g/100 kcal. In one embodiment, standardized high fat human milk composition comprising 38 Cal/oz with a PE ratio of about 2.3 g/100 kcal comprises about 30 mg/mL of protein, 80 mg/mL of carbohydrates and about 94 mg/mL of fat.

In some embodiments, the standardized high fat human milk composition may further comprise one or more constituents selected from the group consisting of: calcium, chloride, copper, iron, magnesium, manganese, phosphorus, potassium, selenium, sodium, and zinc.

In one aspect, the improved clinical outcome for infants with BPD or at risk of developing BPD administered the fortified human milk composition is a shorter length of stay in a hospital. In one embodiment, the length of stay in a hospital is at least about 5 days shorter in infants administered a human milk composition fortified with a pasteurized human cream composition. In another embodiment, the length of stay is at least about 10 days shorter. In another embodiment, the length of stay is at least about 15 days shorter in infants administered a human milk composition fortified with a pasteurized human cream composition. In yet another embodiment, the length of stay is at least about 20 days shorter in infants administered a human milk composition fortified with a pasteurized human cream composition.

In another embodiment, the improved clinical outcome for infants with BPD or at risk of developing BPD administered the fortified human milk composition is an earlier post menstrual age at discharge from a hospital. In one embodiment, the post menstrual age at discharge is at least about 1 week earlier in infants administered a human milk composition fortified with a pasteurized human cream composition. In another embodiment, the post menstrual age at discharge is at least about 3 weeks earlier in infants administered a human milk composition fortified with a pasteurized human cream composition. In another embodiment, the post menstrual age at discharge is at least about 6 weeks earlier in infants administered a human milk composition fortified with a pasteurized human cream composition.

In another embodiment, the improved clinical outcome is an increase in growth metrics. In one embodiment, the increased growth metric is an increase in body length. In another embodiment, the increased growth metric is an increase in body weight, which is particularly important where the body weight is below normal. In another embodiment, the increased growth metric is an increase in head circumference. In one embodiment, the increased growth metric is an increase in both body length and body weight. In another embodiment, the increased growth metric is an increase in both body length, and head circumference. In one embodiment, the increased growth metric is an increase in both body weight and head circumference. In one embodiment the increased growth metric is an increase in all three of body length, body weight and head circumference.

In some embodiments, the compositions of the present invention are useful in preventing BPD in infants who are at risk of developing BPD. In some embodiments, infants at risk for developing BPD are low birth weight infants. In some embodiments, infants at risk for developing BPD are very low birth weight infants. In some embodiments, the compositions of the present invention are useful to decrease the duration and/or severity of BPD in an infant diagnosed with BPD. In some embodiments, a method is provided for identifying/diagnosing an infant with BPD and further for feeding infants with the high fat compositions described herein thereby decreasing the duration and/or severity of BPD. In some embodiments, the decrease in duration and/or severity of BPD is associated with an improved clinical outcome. In some embodiments, an improved clinical outcome is a decreased length of stay in the hospital. In some embodiments, an improved clinical outcome is an earlier post menstrual age at discharge from a hospital. In some embodiments, the improved clinical outcome is one or more of increased body weight, body length or head circumference.

### DETAILED DESCRIPTION OF THE INVENTION

The terms “premature,” “preterm,” and “low-birth-weight (LBW)” infants are used interchangeably and refer to infants born less than 37 weeks gestational age and/or with birth weights less than 2500 g. In particular, the term “very-low-birth-weight (VLBW)” infant refers to an infant with a birth weight of 1250 g or less. Accordingly, the term “LBW infants” includes VLBW infants.

The term “whole milk” refers to milk from which no fat has been removed.

By “bioburden” is meant microbiological contaminants and pathogens (generally living) that can be present in milk, e.g., viruses, bacteria, mold, fungus and the like.

The term “bronchopulmonary dysplasia” or “BPD” refers to a condition low birth weight infants are at risk for, involving abnormal development of lung tissue. It is characterized by inflammation and scarring in the lungs. Infants with BPD may require oxygen therapy and typically need more calories than a VLBW infant without BPD to maintain and/or increase growth.

The term “intraventricular hemorrhage” or “IVH” refers to bleeding into the ventricles, or fluid-filled areas, of the brain. The condition occurs most often in infants that are born premature.

The term “necrotizing enterocolitis” or “NEC” refers to a common and serious intestinal disease among premature infants. NEC occurs when tissue in the small or large intestine is injured or begins to die off, possibly due to causes such as too little oxygen or blood flow to the intestine at birth, an underdeveloped intestine, injury to the intestinal lining, heavy growth of bacteria in the intestine and formula feeding. The inability of the intestine to hold waste once injured could lead to escape of bacteria and other waste products into the infant's bloodstream or abdominal cavity and possible subsequent infection.

The term “patent ductus arteriosus” or “PDA” is a condition in which the ductus arteriosus, a blood vessel that allows blood to go around the infant's lungs before birth, does not close. It usually closes about a few days after birth when the infant's lungs fill with air. PDA causes abnormal blood flow between the aorta and pulmonary artery, two major blood vessels that carry blood from the heart.

The term “post menstrual age” or “PMA” is the time elapsed between the first day of the last menstrual period and birth (gestational age) plus the time elapsed after birth (chronological age).

The term “respiratory distress syndrome” or “RDS” refers to a condition that makes it hard for the infant to breath. This difficulty in breathing could be due to underdeveloped lungs. The underdeveloped lungs could lack surfactant. Surfactant is a slippery substance that helps the lungs fill with air and prevents the air sacs from deflating.

The term “sepsis” refers to a potentially life-threatening complication of an infection. Sepsis happens when chemicals released into the bloodstream to fight the infection trigger inflammatory responses throughout the body. This inflammation can trigger a cascade of changes that can damage multiple organ systems, causing them to fail.

By “mixed human milk composition” or “mixed composition” or “mixed formulation” or any human milk product indicated as “mixed” is meant a composition wherein a fortifier (e.g. a human cream fortifier) has been mixed with a separate milk formulation for use in feeding to an infant. In some embodiments, the fortifiers described herein may be mixed with the infant's mother's own milk, donor milk, a standardized ready to feed human milk formulation or other human or non-human milk or infant formula. A “mixed composition” therefore is a ready to feed composition.

As used herein the term “ready to feed” when used to describe human milk formulations/compositions refers to milk that is ready to be fed to an infant (i.e. not a fortifier). In some embodiments, the ready to feed composition is made by mixing a fortifier with donor milk, mother's own milk, or other standardized milk formulation. In some embodiments, the ready to feed composition is formulated directly from pooled human milk donations and is provided to the infant in a form that is ready to feed without additional mixing. Such ready to feed formulations formulated directly from pooled human milk donations is also be referred to as “standardized human milk formulations.” The formulations are “standardized” because they contain specific (i.e. standardized) levels of constituents (i.e. fat, protein and carbohydrates). Thus, as used herein “standardized high fat human milk formulations” or “high fat standardized human milk formulations” are ready to feed formulations made directly by producing the formulation from human milk donations. While “ready to feed high fat formulations” are made either from mixing a high fat fortifier with ready to feed milk (mother's own milk, donor milk, or other standardized milk formulation) or are made directly from human milk donations.

As used herein “fortifier” means any human milk composition that is added to another milk formulation (human or otherwise) to arrive at a ready to feed formulation.

All patents, patent applications, and references cited herein are incorporated in their entireties by reference. Unless defined otherwise, technical and scientific terms used herein have the same meaning as that commonly understood by one of skill in the art.

The compositions and methods featured herein relate to human milk cream products. The rationale behind supplementing human milk (e.g., mother's or donor) stems from the finding that milk from mothers who deliver significantly prematurely does not have adequate nutritional content to completely meet the increased metabolic and growth needs of their infants relative to a full-term infant (Hawthorne et al., Minerva Pediatr, 56:359-372, 2004; Lawrence and Lawrence, Breastfeeding: A Guide for the Medical Profession, 6^{th} edition. Philadelphia: Elsevier Mosby, 2005; and Ziegler, Human Milk for the Preterm Infant, International Congress of the Human Milk Banking Association of North America. Alexandria, Va., 2005).

Interestingly, so called “pre-term milk” may contain higher levels of protein than milk from a mother who has delivered at term (Hawthorne et al., Minerva Pediatr, 56:359-372, 2004; Lawrence and Lawrence, Breastfeeding: A Guide for the Medical Profession, 6^{th} edition. Philadelphia: Elsevier Mosby, 2005; and Ziegler, Human Milk for the Preterm Infant, International Congress of the Human Milk Banking Association of North America. Alexandria, Va., 2005). Yet, these levels are still inadequate to ensure appropriate initial levels of growth and development and beyond, particularly in infants of a size destined not to survive in the days before neonatal intensive care. It is also the case that these elevated nutrition levels are relatively short-lived, and the “pre-term milk” rapidly becomes indistinguishable from term milk. Thus, it is critical that the nutritional content of the daily feedings for these infants meet acceptable levels of key components such as calories and protein.

However, the caloric content of the human milk supplied to infants is very rarely measured. As demonstrated by the study performed by Wocjik et al. (J Am Diet Assoc, 109:137-140, 2009), it is likely that the human milk being supplied to LBW and VLBW infants is often not providing a sufficient amount of calories to meet the nutritional needs of a pre-term infant. Wocjik et al. 2009 found that the average energy content of a nationwide sample of donor breast milk was 19 kcal/oz with 25% of samples falling below 17.3 kcal/oz and 65% of the samples below 20 kcal/oz. Another similar analysis of both donor and mother's own milk demonstrated that many samples had nutrient contents below the recommended values for preterm milk composition, demonstrating that 79% had a fat content less than 4 g/dL, 56% had a protein content less 1.5 g/dL, and 67% had an energy density less than 67 kcal/dL (De Halleux V, Rigo J. Variability in human milk composition: benefit of individualized fortification in very-low-birth-weight infants. Am J Clin Nutr 2013; 98: 529S-35S). Moreover, the mineral content of unfortified human milk is often insufficient to meet the higher nutrient needs of premature infants (Schanler, 2011). The high fat human milk compositions described herein provide a solution to this problem and may be used, e.g., to supplement human milk in order to increase the caloric content to the desired level without increasing the volume to be fed to the infant, e.g., a LBW infant with BPD. This is particularly useful when all that is needed is increased caloric intake and not increased protein content. The compositions of the current invention solve this problem by increasing calories without increasing protein and therefore provide a more cost effective solution to the problem.

Alternatively, high fat standardized human milk compositions may be made as ready to feed formulations processed from pooled donor milk, thus negating the requirement for precise mixing with mother's own milk, donor milk and/or other standardized milk formulations. These high fat ready to feed human milk compositions are able to tightly control the amounts of fat, proteins, carbohydrates and fluid volume fed to these infants.

Total parenteral nutrition (TPN), a process of providing nutrition intravenously and bypassing the gastrointestinal tract, is often used to feed LBW infants. However, TPN is associated with several potential complications including, e.g., hyperglycemia, hypoglycemia, lipogenesis, hepatic complications (e.g., fatty liver and cholestasis), sepsis, and blood clots. In particular, the high fat and high protein requirements of the LBW infant tend to result in liver dysfunction when the nutrition is received parenterally. Accordingly, it is desirable to provide an infant with enteral nutrition as soon as possible rather than TPN, in order to avoid the negative effects associated with TPN. The high fat human milk compositions described herein can be used to increase the caloric content and fat content of human milk, thereby providing means for enteral delivery of human milk fat. Maintaining a fully human milk based diet reduces the incidence of complications such as necrotizing enterocolitis, and therefore, it is contemplated that enteral feeds of human milk supplemented with high fat human milk products may be used in place of TPN.

Bronchopulmonary dysplasia (BPD) involves abnormal development of lung tissue. It is characterized by inflammation and scarring in the lungs. Babies who are born prematurely, and thus have underdeveloped lungs, or who experience respiratory problems shortly after birth are at risk for bronchopulmonary dysplasia (BPD), sometimes called chronic lung disease. Growth failure in infants with BPD is predominantly due to malnutrition. Infants developing BPD require 20 to 40% more calories than their aged matched controls (Binwale and Ehrenkranz, 2006 and Theile et al, 2012). Despite their increased caloric needs, infants with comorbidities such as BPD receive more fluid and less energy than healthy comparisons in the first seven days of life due to their more critically ill status (Ehrenkranz R A. Ongoing issues in the intensive care for the periviable infant—Nutritional management and prevention of bronchopulmonary dysplasia and nosocomial infections. Semin Perinatol 2014; 38: 25-30). This tendency has been shown to extend until at least five weeks of life (Ehrenkranz R A. Early, Aggressive Nutritional Management for Very Low Birth Weight Infants: What is the Evidence? Semin Perinatol 2007; 31: 48-55). Future nutrition and growth can then be further compromised by the need for fluid restriction, diuretics, and post-natal steroids to manage this disease (Theile et al, 2012), making the energy density of feeds of upmost importance.

### Human Cream Compositions

The high fat human milk fortifier compositions, or human cream fortifier compositions, described herein are produced from whole human milk. In one embodiment, the human cream composition comprises about 2.0 kcal to about 3.0 kcal or more per ml. In a preferred embodiment, the human cream composition comprises about 2.5 kcal/ml. It is contemplated that the human cream composition may comprise about 18% to about 30% or more fat (i.e., lipids). In one embodiment, the human cream composition is about 25% fat.

It is contemplated that the human cream compositions described herein may comprise one or more additional components in order to have the desired caloric content and/or desired percentage of fat. Accordingly, in one embodiment, the human cream composition comprises added human skim milk permeate. The skim milk permeate (“permeate”) is the liquid produced by the ultrafiltration of human skim milk. Permeate contains valuable human milk oligosaccharides. The permeate added to the human cream composition can be concentrated, diluted or left neat. In another embodiment, the human cream composition comprises deionized (DI) water in addition to high fat human milk.

Generally, the human cream composition is frozen for storage and/or shipment and is thawed prior to use.

In some embodiments, the human cream fortifiers are mixed with mother's own milk, donor human milk, or standardized human or non-human milk to produce a mixed composition that can deliver about 30 to about 40 Cal/oz. In some embodiments, the mixed composition delivers about 32 Cal/oz and has a protein to energy ratio of about 2.16 g/100 kcal. In such an embodiment, the mixed human milk composition delivers approximately 23 mg/mL of protein and about 74 mg/mL of fat. In another embodiment, the mixed composition delivers about 32 Cal/oz and has a protein to energy ratio of about 2.77 g/100 kcal. In such an embodiment, the mixed human milk composition delivers approximately 30 mg/mL of protein and about 71 mg/mL of fat. In another embodiment, the mixed composition delivers about 38 Cal/oz and has a protein to energy ratio of about 1.82 g/kcal. In such an embodiment, the mixed human milk composition delivers about 23 mg/mL of protein and about 97 mg/mL of fat. In another embodiment, the mixed composition delivers about 38 Cal/oz and has a protein to energy ratio of about 2.34 g/kcal. In such an embodiment, the mixed human milk composition delivers about 30 mg/mL of protein and about 94 mg/mL of fat.

In some embodiments, in addition to mixing the human cream fortifier of the present invention, human milk fortifiers such as those described in U.S. Pat. No. 8,545,920 may also be mixed with mother's milk, donor milk, or other standardized human or non-human milk formula to arrive at the mixed compositions described above.

### High Fat Standardized Human Milk Compositions

Provided according to the present invention are also standardized human milk compositions which are formulated to deliver high levels of human fat and therefore overall calories without substantially increasing protein content beyond normal protein fortification levels. These standardized human milk formulations are made from pooled human milk and generally deliver between 30 and 40 Cal/oz with protein to energy ratios ranging from between about 1.5 g/100 kcal to about 3.0 g/100 kcal. More specifically, the PE ratios range between about 1.8 g/100 kcal and 2.8 g/100 kcal. In certain embodiments, the standardized human milk compositions deliver between about 70 and about 100 mg/mL of fat and between about 20 and about 30 mg/mL of protein. In these embodiments, the standardized human milk composition also delivers approximately 80 mg/mL of carbohydrates. Exemplary standardized human milk compositions are provided in Table 1.

TABLE 1
Exemplary Standardized Human Milk Compositions

| | | | Carbohydrate |
|---|---|---|---|
| Cal/Oz (PE Ratio) | Protein (mg/mL) | Fat (mg/mL) | (mg/mL) |
| 32 Cal/Oz (2.16 g/ | 23 mg/mL | 74 mg/mL | 80 mg/mL |
| 100 kcal) | | | |
| 32 Cal/Oz (2.77 g/ | 30 mg/mL | 71 mg/mL | 80 mg/mL |
| 100 kcal) | | | |
| 38 Cal/oz (1.82 g/kcal) | 23 mg/mL | 97 mg/mL | 80 mg/mL |
| 38 Cal/oz (2.34 g/kcal) | 30 mg/mL | 94 mg/mL | 80 mg/mL |

### Specific Components of the Featured Compositions

One component of the milk compositions featured herein is protein. In the body, protein is needed for growth, synthesis of enzymes and hormones, and replacement of protein lost from the skin, urine and feces. These metabolic processes determine the need for both the total amount of protein in a feeding and the relative amounts of specific amino acids. The adequacy of the amount and type of protein in a feeding for subjects is determined by measuring growth, nitrogen absorption and retention, plasma amino acids, certain blood analytes, and metabolic responses.

Another constituent of the milk compositions described herein is fat. Fat is generally a source of energy for subjects, not only because of its high caloric density but also because of its low osmotic activity in solution.

Vitamins and minerals are important to proper nutrition and development of subjects. A subject requires electrolytes, e.g., sodium, potassium and chloride for growth and for acid-base balance. Sufficient intakes of these electrolytes are also needed for replacement of losses in the urine and stool and from the skin. Calcium, phosphorus and magnesium are needed for proper bone mineralization and growth.

Trace minerals are associated with cell division, immune function and growth. Consequently, sufficient amounts of trace minerals are needed for subject growth and development. Some trace minerals that are important include, e.g., copper, magnesium and iron (which is important, e.g., for the synthesis of hemoglobin, myoglobin and iron-containing enzymes). Zinc is needed, e.g., for growth, for the activity of numerous enzymes, and for DNA, RNA and protein synthesis. Copper is necessary for, e.g., the activity of several important enzymes. Manganese is needed, e.g., for the development of bone and cartilage and is important in the synthesis of polysaccharides and glycoproteins. Accordingly, the human milk formulations and compositions of the invention can be supplemented with vitamins and minerals as described herein.

Vitamin A is a fat-soluble vitamin essential for, e.g., growth, cell differentiation, vision and proper functioning of the immune system. Vitamin D is important, e.g., for absorption of calcium and to a lesser extent, phosphorus, and for the development of bone. Vitamin E (tocopherol) prevents peroxidation of polyunsaturated fatty acids in the cell, thus preventing tissue damage. Folic acid plays a role in, e.g., amino acid and nucleotide metabolism.

As described above, the variability of human milk vitamin and mineral concentrations often require some fortification to insure that a child is receiving adequate amounts of vitamins and minerals. Examples of vitamins and minerals that can be added to the human milk compositions featured herein include: vitamin A, vitamin B1, vitamin B2, vitamin B6, vitamin B12, vitamin C, vitamin D, vitamin E, vitamin K, biotin, folic acid, pantothenic acid, niacin, m-inositol, calcium, phosphorus, magnesium, zinc, manganese, copper, selenium, sodium, potassium, chloride, iron and selenium. The compositions can also be supplemented with: chromium, molybdenum, iodine, taurine, carnitine and choline may also require supplementation.

The osmolality of standardized human milk formulations featured herein can affect adsorption, absorption, and digestion of the compositions. High osmolality, e.g., above about 400 mOsm/Kg H₂O, has been associated with increased rates of necrotizing enterocolitis (NEC), a gastrointestinal disease that affects neonates (see, e.g., Srinivasan et al., Arch. Dis. Child Fetal Neonatal Ed. 89:514-17, 2004). The osmolality of the human milk compositions of the disclosure is typically less than about 400 mOsm/Kg H₂O. The osmolality can be adjusted by methods known in the art.

### Methods of Making Human Cream Compositions and High Fat Standardized Human Milk Compositions

The human cream compositions and standardized high fat standardized human milk compositions described herein are produced from whole human milk. The human milk may be obtained from an infant's own mother or from one or more donors. In certain embodiments, the human milk is pooled to provide a pool of human milk. For example, a pool of human milk comprises milk from two or more (e.g., ten or more) donors. As another example, a pool of human milk comprises two or more donations from one donor.

### Obtaining Donor Milk

Generally, human milk is provided by donors, and the donors are pre-screened and approved before any milk is processed. Various techniques are used to identify and qualify suitable donors. A potential donor must obtain a release from her physician and her child's pediatrician as part of the approval process. This helps to insure, inter alia, that the donor is not chronically ill and that her child will not suffer as a result of the donation(s). Methods and systems for qualifying and monitoring milk collection and distribution are described, e.g., in U.S. patent application Ser. No. 12/728,811 (U.S. 2010/0268658), which is incorporated herein by reference in its entirety. Donors may or may not be compensated for their donation.

Usually, donor screening includes a comprehensive lifestyle and medical history questionnaire that includes an evaluation of prescription and non-prescription medications, testing for drugs of abuse, and testing for certain pathogens. The donor or her milk may be screened for, e.g., human immunodeficiency virus Type 1 (HIV-1), HIV-2, human T-lymphotropic virus Type 1 (HTLV-I), HTLV-II, hepatitis B virus (HBV), hepatitis C virus (HCV), and syphilis. These examples are not meant to be an exhaustive list of all possible pathogens to be screened for.

Donors may be periodically requalified. For example, a donor is required to undergo screening by the protocol used in their initial qualification every four months, if the donor wishes to continue to donate. A donor who does not requalify or fails qualification is deferred until such time as they do, or permanently deferred if warranted by the results of requalification screening. In the event of the latter situation, all remaining milk provided by that donor is removed from inventory and destroyed or used for research purposes only.

A donor may donate at a designated facility (e.g., a milk bank office) or, in a preferred embodiment, express milk at home. If the donor will be expressing milk at home, she will measure the temperature in her freezer with, e.g., a supplied thermometer to confirm that it is cold enough to store human milk in order to be approved.

Testing Donor Identity

Once the donor has been approved, donor identity matching may be performed on donated human milk because the milk may be expressed by a donor at her home and not collected at a milk banking facility. In a particular embodiment, each donor's milk can be sampled for genetic markers, e.g., DNA markers, to guarantee that the milk is truly from the approved donor. Such subject identification techniques are known in the art (see, e.g., International Application Serial No. PCT/US2006/36827, which is incorporated herein by reference in its entirety). The milk may be stored (e.g., at −20° C. or colder) and quarantined until the test results are received.

For example, the methods featured herein may include a step for obtaining a biological reference sample from a potential human breast milk donor. Such sample may be obtained by methods known in the art such as, but not limited to, a cheek swab sample of cells, or a drawn blood sample, milk, saliva, hair roots, or other convenient tissue. Samples of reference donor nucleic acids (e.g., genomic DNA) can be isolated from any convenient biological sample including, but not limited to, milk, saliva, buccal cells, hair roots, blood, and any other suitable cell or tissue sample with intact interphase nuclei or metaphase cells. The sample is labeled with a unique reference number. The sample can be analyzed at or around the time of obtaining the sample for one or more markers that can identify the potential donor. Results of the analysis can be stored, e.g., on a computer-readable medium. Alternatively, or in addition, the sample can be stored and analyzed for identifying markers at a later time.

It is contemplated that the biological reference sample may be DNA typed by methods known in the art such as STR analysis of STR loci, HLA analysis of HLA loci or multiple gene analysis of individual genes/alleles. The DNA-type profile of the reference sample is recorded and stored, e.g., on a computer-readable medium.

It is further contemplated that the biological reference sample may be tested for self-antigens using antibodies known in the art or other methods to determine a self-antigen profile. The antigen (or another peptide) profile can be recorded and stored, e.g., on a computer-readable medium.

A test sample of human milk is taken for identification of one or more identity markers. The sample of the donated human milk is analyzed for the same marker or markers as the donor's reference sample. The marker profiles of the reference biological sample and of the donated milk are compared. The match between the markers (and lack of any additional unmatched markers) would indicate that the donated milk comes from the same individual as the one who donated the reference sample. Lack of a match (or presence of additional unmatched markers) would indicate that the donated milk either comes from a non-tested donor or has been contaminated with fluid from a non-tested donor.

The donated human milk sample and the donated reference biological sample can be tested for more than one marker. For example, each sample can be tested for multiple DNA markers and/or peptide markers. Both samples, however, need to be tested for at least some of the same markers in order to compare the markers from each sample.

Thus, the reference sample and the donated human milk sample may be tested for the presence of differing identity marker profiles. If there are no identity marker profiles other than the identity marker profile from the expected subject, it generally indicates that there was no fluid (e.g., milk) from other humans or animals contaminating the donated human milk. If there are signals other than the expected signal for that subject, the results are indicative of contamination. Such contamination will result in the milk failing the testing.

The testing of the reference sample and of the donated human milk can be carried out at the donation facility and/or milk processing facility. The results of the reference sample tests can be stored and compared against any future donations by the same donor.

Screening for Contaminants

The milk is then tested for pathogens. The milk may be genetically screened, e.g., by polymerase chain reaction (PCR), to identify, e.g., viruses, such as HIV-1, HBV and HCV. A microorganism panel that screens for various bacterial species, fungus and mold via culture may also be used to detect contaminants. For example, a microorganism panel may test for aerobic count, Bacillius cereus, Escherichia coli, Salmonella, Pseudomonas, coliforms, Staphylococcus aureus, yeast and mold. In particular, B. cereus is a pathogenic bacterium that cannot be removed through pasteurization. Pathogen screening may be performed both before and after pasteurization.

In addition to screening for pathogens, the donor milk may also be tested for drugs of abuse (e.g., cocaine, opiates, synthetic opioids (e.g. oxycodone/oxymorphone) methamphetamines, benzodiazepine, amphetamines, and THC) and/or adulterants such as non-human proteins. For example, an ELISA may be used to test the milk for a non-human protein, such as bovine proteins, to ensure, e.g., that cow milk or cow milk infant formula has not been added to the human milk, for example to increase donation volume when donors are compensated for donations.

The donor milk may also be screened for one or more adulterants. Adulterants include any non-human milk fluid or filler that is added to a human milk donation, thereby causing the donation to no longer be unadulterated, pure human milk. Particular adulterants to be screened for include non-human milk and infant formula. As used herein, “non-human milk” refers to both animal-, plant- and synthetically-derived milks. Examples of non-human animal milk include, but are not limited to, buffalo milk, camel milk, cow milk, donkey milk, goat milk, horse milk, reindeer milk, sheep milk, and yak milk. Examples of non-human plant-derived milk include, but are not limited to, almond milk, coconut milk, hemp milk, oat milk, rice milk, and soy milk. Examples of infant formula include, cow milk formula, soy formula, hydrolysate formula (e.g., partially hydrolyzed formula or extensively hydrolyzed formula), and amino acid or elemental formula. Cow milk formula may also be referred to as dairy-based formula. In particular embodiments, the adulterants that are screened for include cow milk, cow milk formula, goat milk, soy milk, and soy formula.

Methods known in the art may be adapted to detect non-human milk proteins, e.g., cow milk and soy proteins, in a human milk sample. In particular, immunoassays that utilize antibodies specific for a protein found in an adulterant that is not found in human milk can be used to detect the presence of the protein in a human milk sample. For example, an enzyme-linked immunosorbent assay (ELISA), such as a sandwich ELISA, may be used to detect the presence of an adulterant in a human milk sample. An ELISA may be performed manually or be automated. Another common protein detection assay is a western blot, or immunoblot. Flow cytometry is another immunoassay technique that may be used to detect an adulterant in a human milk sample. ELISA, western blot, and flow cytometry protocols are well known in the art and related kits are commercially available. Another useful method to detect adulterants in human milk is infrared spectroscopy and in particular mid-range Fourier transform infrared spectrometry (FTIR).

The human milk may be pooled prior to screening. In one embodiment, the human milk is pooled from more than one donation from the same individual. In another embodiment, the human milk is pooled from two or more, three or more, four or more, five or more, six or more, seven or more, eight or more, nine or more, or ten or more individuals. In a particular embodiment, the human milk is pooled from ten or more individuals. The human milk may be pooled prior to obtaining a sample by mixing human milk from two or more individuals. Alternatively, human milk samples may be pooled after they have been obtained, thereby keeping the remainder of each donation separate.

The screening step will yield a positive result if the adulterant is present in the human milk sample at about 20% or more, about 15% or more, about 10% or more, about 5% or more, about 4% or more, about 3% or more, about 2% or more, about 1% or more, or about 0.5% or more of the total volume of the milk donation.

The screening of the donated human milk for one or more adulterants can be carried out at the donation facility and/or milk processing facility.

Human milk that has been determined to be free of an adulterant, or was found to be negative for the adulterant, is selected and may be stored and/or further processed. Human milk that contains an adulterant will be discarded and the donor may be disqualified. For example, if an adulterant is found in one or more human milk samples from the same donor, the donor is disqualified. In some embodiments, when an adulterant if found in two or more human milk samples from the same donor, the donor is disqualified.

Processing Human Milk

Once the human milk has been screened, it is processed to produce a high fat product, e.g., a human cream fortifier composition or a high fat standardized human milk composition. The donation facility and milk processing facility can be the same or different facility. Processing of milk can be carried out with large volumes of human milk, e.g., about 75 liters/lot to about 10,000 liters/lot of starting material (e.g. about 2,500 liters/lot or about 2,700 liters/lot or about 3,000 liters/lot or about 5,000 liters/lot or about 7,000 liters/lot or about 7,500 liters/lot or about 10,000 liters/lot).

Methods of obtaining compositions that include lipids from human milk to provide nutrition to patients are described in PCT Application PCT/US07/86973 filed on Dec. 10, 2007 (WO 2008/073888), the contents of which are incorporated herein in their entirety.

After the human milk is carefully analyzed for both identification purposes and to avoid contamination as described above, the milk then undergoes filtering, e.g., through about a 200 micron filter, and heat treatment. For example, the composition can be treated at about 63° C. or greater for about 30 minutes or more. Next, the milk is transferred to a separator, e.g., a centrifuge, to separate the cream (i.e., the fat portion) from the skim. The skim can be transferred into a second processing tank where it remains at about 2 to 8° C. until a filtration step. Optionally, the cream separated from the skim, can undergo separation again to remove more skim.

Following the separation of cream and skim, the skim portion undergoes further filtration, e.g., ultrafiltration. This process concentrates the nutrients in the skim milk by filtering out the water. The water obtained during the concentration is referred to as the permeate. The resulting skim portion can be further processed to produce human milk fortifiers and/or standardized human milk formulations.

Processing of human milk to obtain human milk fortifiers (e.g., PROLACTPLUS™ Human Milk Fortifiers, e.g., PROLACT+4®, PROLACT+6®, PROLACT+8®, and/or PROLACT+10®, which are produced from human milk and contain various concentrations of nutritional components) and the compositions of the fortifiers are described in U.S. patent application Ser. No. 11/947,580, filed on Nov. 29, 2007, (U.S. 2008/0124430) the contents of which are incorporated herein in their entirety. These fortifiers can be added to the milk of a nursing mother to enhance the nutritional content of the milk for, e.g., a preterm infant.

Methods of obtaining standardized human milk formulations (exemplified by PROLACT20™, and/or PROLACT24™) and formulations themselves are also discussed in U.S. patent application Ser. No. 11/947,580, filed on Nov. 29, 2007, (U.S. 2008/0124430) the contents of which are incorporated herein in their entirety. These standardized human milk formulations can be used to feed, e.g., infants. They provide a nutritional human-derived formulation and can substitute for mother's milk. Similarly, the methods for obtaining standardized human milk formulations described therein may be used to produce the high fat standardized human milk compositions of the current invention.

Formulating Human Cream Compositions

Once the cream portion has been separated from the skim portion, the caloric content of the cream portion is measured. In one preferred embodiment, if the caloric content or the percentage of fat of the cream portion is above a desired level, a volume of the permeate from the ultrafiltration of the skim portion may be added to the cream portion, thereby providing a formulated human cream composition that has the desired caloric content. Alternatively, in another preferred embodiment, deionized water may be added to the cream portion in order to provide the formulated human cream composition. For example, the desired caloric content of the human cream composition is about 2.0 kcal to about 3.0 kcal or more per ml. In a preferred embodiment, the desired caloric content is about 2.5 kcal/ml. In another example, the desired percentage of fat of the human cream composition is about 20% to about 30% or more lipids. In certain embodiments, the desired percentage of fat is about 25% lipids.

Packaging and Pasteurization

After optionally adding permeate or deionized water to the cream, the cream composition undergoes pasteurization. For example, the composition can be placed in a process tank that is connected to the high-temperature, short-time (HTST) pasteurizer via platinum-cured silastic tubing. After pasteurization, the cream composition can be collected into a second process tank and cooled. Other methods of pasteurization known in the art can be used. For example, in vat pasteurization the cream composition in the tank is heated to a minimum of 63° C. and held at that temperature for a minimum of thirty minutes. The air above the cream composition is steam heated to at least three degrees Celsius above the cream composition temperature. In one embodiment, the product temperature is about 66° C. or greater, the air temperature above the product is about 69° C. or greater, and the product is pasteurized for about 30 minutes or longer. In another embodiment, both HTST and vat pasteurization are performed.

The pasteurized cream composition is generally processed aseptically. After cooling to about 2 to 8° C., the product is filled into containers of desired volumes, and various samples of the cream composition are taken for nutritional and bioburden analysis. The nutritional analysis ensures proper calorie and fat content of the cream composition. A label that reflects the nutritional analysis is generated for each container. The bioburden analysis tests for presence of microbial contaminants, e.g., total aerobic count, B. cereus, E. coli, Coliform, Pseudomonas, Salmonella, Staphylococcus, yeast, and/or mold. Bioburden testing can be genetic testing. The product is packaged and shipped once the analysis is complete and desired results are obtained.

In one embodiment, the resultant human cream composition comprises about 2.0 kcal to about 3.0 kcal or more per ml. In a preferred embodiment, the human cream composition comprises about 2.5 kcal/ml. It is contemplated that the resultant human cream composition comprises about 20% to about 30% or more fat. In one embodiment, the human cream composition is about 25% fat.

### Use of Human Cream Compositions and High Fat Standardized Human Milk Compositions

The human cream compositions described herein may be used as supplemental nutrition. Accordingly, the human cream compositions described herein may be administered enterally or orally (e.g., bottle feeding). The use of human lipids for parenteral nutrition, a practice of intravenous feeding (e.g., total parenteral nutrition), for a patient in need thereof is described in PCT Application PCT/US07/86973 filed on Dec. 10, 2007 (WO 2008/073888), the contents of which are incorporated herein in their entirety.

The disclosed human cream compositions are particularly useful for supplementing human milk for infants, especially LBW infants with BPD or those at increased risk of developing BPD, in order to raise the caloric content of the human milk to a desired level. Similarly, the high fat standardized human milk compositions described herein are also particularly useful as a ready to feed formulation for feeding to LBW infants with BPD or at risk of developing BPD, in order to deliver the necessary caloric content to the VLB infant without an added step of mixing a fortifier with mother's milk or another donor/standardized milk formulation. Human milk is often administered enterally to preterm infants in the NICU. Enteral nutrition is a practice of tube feeding, e.g., nasogastric, orogastric, transpyloric, and percutaneous. Human milk (e.g., mother's own or donor) often does not meet the caloric requirements of a LBW infant (Wocjik et al. J Am Diet Assoc, 109:137-140, 2009). Therefore, in one embodiment, the human cream composition of the current invention is added to the human milk, thereby increasing the caloric content while also maintaining the entirely human milk diet of the infant and avoiding the complications associated with TPN. Similarly, a ready to feed human milk composition that mimics the cream-fortified milk may be produced from donor milk thereby avoiding the need to mix a human cream fortifier with mother's milk or in the event that mothers milk or donor milk is not available. In one embodiment, the enteral nutrition comprising the human cream composition or standardized high fat human milk composition is for a preterm or LBW infant. In another embodiment, the enteral nutrition comprising the human cream composition or standardized high fat human milk composition is for a preterm or LBW infant with bronchopulmonary dysplasia (BPD).

The human cream compositions and high fat standardized human milk compositions described herein may be used to feed infants with BPD or at risk of developing BPD. In one embodiment, the feedings result in an improved clinical outcome. In one embodiment, the improved clinical outcome is a shorter length of stay in a hospital for the infant with BPD or at risk of developing BPD administered a human milk composition fortified with a pasteurized human milk cream composition. In one embodiment, the length of stay is at least 1, 2, 3, 4, 5, 6, 7, 8, 9, 10, 11, 12, 13, 14, 15, 16, 17, 18, 19, or 20 days or more shorter for the infant with BPD or at risk of developing BPD. In another embodiment, the improved clinical outcome is an earlier post menstrual age at discharge from a hospital of the infant with BPD or at risk of developing BPD administered a human milk composition fortified with a pasteurized human milk cream composition. In one embodiment, the post menstrual age at discharge is at least 1, 2, 3, 4, 5, or 6 weeks or more earlier for the infant with BPD or at risk of developing BPD. In one embodiment, the improved clinical outcome associated with the delivery of the human cream compositions or high fat standardized human milk compositions of the present invention is an increase in growth metrics including body length, body weight and/or head circumference.

In one embodiment, the improved clinical outcome associated with the delivery of the human cream compositions or high fat standardized human milk compositions of the present invention is a decrease in the incidence and/or severity of BPD.

In one embodiment, a method of increasing the caloric content of human milk to a desired caloric content level is provided. The method comprises the steps of obtaining a sample of human milk (e.g., mother's own or donor or pool of milk derived from the mother and/or donors), measuring the caloric content of the human milk, determining a volume of a human milk cream composition needed to raise the caloric content of the human milk to the desired caloric content level, and adding the volume of the human milk cream composition to the container of human milk. For example, the desired caloric content is 20 kcal/oz or more. In another embodiment, the desired calorie target is 24 kcal/oz or more. In another embodiment, the desired calorie target is 26 kcal/oz or more. In another embodiment, the desired caloric target is 28 kcal/oz or more. In another embodiment, the desired caloric target is 30 kcal/oz or more. In another embodiment, the desired caloric target is 32 kcal/oz or more. In another embodiment, the desired caloric target is 34 kcal/oz or more. In another embodiment, the desired caloric target is 36 kcal/oz or more. In another embodiment, the desired caloric target is 38 kcal/oz or more. In another embodiment, the desired caloric target is 40 kcal/oz or more. The human milk cream composition used to increase the caloric content of the human milk may comprise, e.g., about 2.5 kcal/ml and/or about 25% fat.

In certain instances it may also be necessary to fortify the human milk composition with a protein containing human milk fortifier. Particularly preferred human milk fortifiers include the Prolact⁺™ line of fortifiers described, for example, in U.S. Pat. No. 8,545,920.

In some instances the infant to be fed's mother's own milk is not available. In such instances donor milk may be used in accordance with the methods of the current invention. Alternatively, a standardized ready to feed formulation of human milk, for example, PROLACT20™ or Prolact24⁺™ may also be used. In rare instances, human milk may not be available at all, in such instances infant formulas and non-human milk fortifiers may be used in accordance with the methods of the current invention.

In some instances, it may be desirable to reduce the amount of human milk that the human cream composition is added to in order to keep the total volume administered or fed to the infant the same. For example, an equal volume of human milk may be removed prior to the addition of the cream composition.

All documents cited herein are expressly incorporated by reference in their entireties for all purposes.

### EXAMPLES

The following examples are intended to illustrate but not limit the disclosure.

### Example 1

### Human Milk Cream Fortifier Product

In order to provide a nutritional supplement that can add the desired amounts of calories to mother's own or donor milk without adding a significant amount of volume, a human cream fortifier composition was produced that can be delivered enterally, thereby avoiding the negative effects associated with TPN. Human milk from previously screened and approved donors was mixed together to generate a pool of donor milk. In a clean room environment, the pool of donor milk was further tested for specific pathogens and bovine proteins. Specifically, PCR testing was used to screen for the presence of HIV-1, HBV, and HCV in the milk. A microbiological panel was also performed that tests for, e.g., aerobic count, Bacillius cereus, Escherichia coli, Salmonella, Pseudomonas, coliforms, Staphylococcus aureus, yeast and mold.

The pool of donor milk was ultracentrifuged to generate a cream portion and a skim milk portion. The cream portion was then formulated to meet specific fat and calorie specifications by adding an amount of the water ultra-filtered from the skim portion, the human skim milk ultrafiltration permeate. Specifically, the cream portion was standardized to 25% lipids and contained about 2.5 kcal/ml.

The standardized cream composition was then pasteurized following guidance set by the FDA's Pasteurized Milk Ordinance. Following pasteurization, the standardized cream composition was then filled into high density polyethylene bottles and frozen. The bottles were weighed to ensure that the intended volume was filled into the bottle. The bottled cream composition was then quarantined until all data from the microbiological panel was reviewed and a full nutritional analysis was performed.

The bottled cream composition was labeled with a lot specific “use by” date and product lot number. The cream product was then shipped frozen to the destination, e.g., hospital, in an insulated cooler packed with dry ice.

### Example 2

### Standardized High Fat Human Milk Compositions

In order to provide a standardized ready to feed formulation that can deliver a high level of calories without adding a significant amount of volume, high fat human milk human compositions are produced that can be delivered enterally, thereby avoiding the negative effects associated with TPN. Human milk from previously screened and approved donors is mixed together to generate a pool of donor milk. In a clean room environment, the pool of donor milk is further tested for specific pathogens and bovine proteins. Specifically, PCR testing is used to screen for the presence of HIV-1, HBV, and HCV in the milk. A microbiological panel is also performed that tests for, e.g., aerobic count, Bacillius cereus, Escherichia coli, Salmonella, Pseudomonas, coliforms, Staphylococcus aureus, yeast and mold.

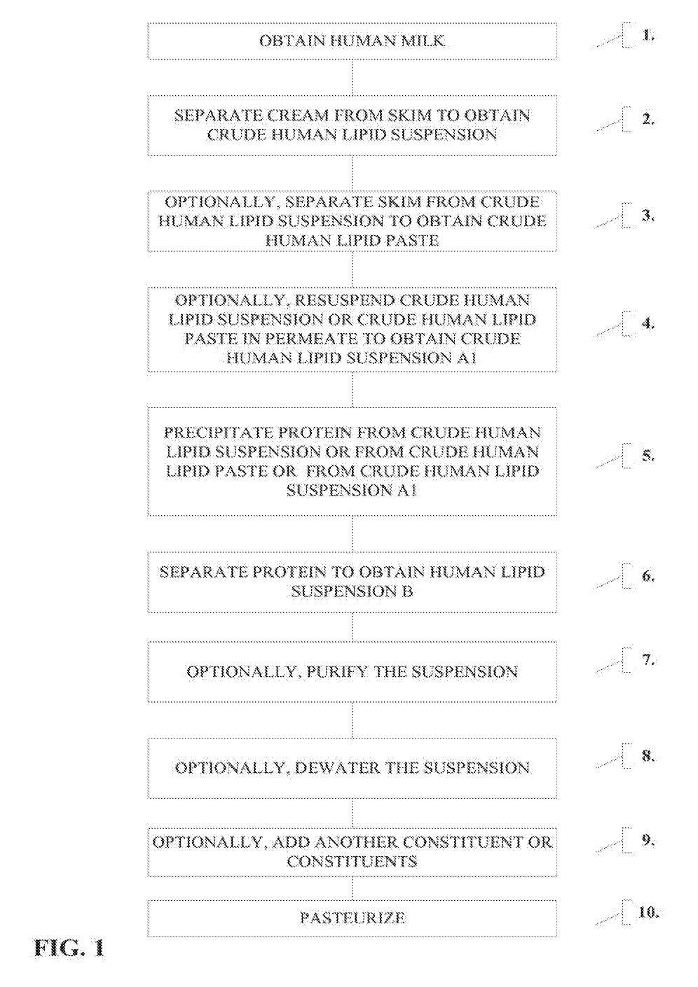

FIG. 1 is a chart showing an embodiment of generating a human milk fortifier. The screened, pooled milk undergoes filtering, e.g., through about a 200 micron filter (step 2), and heat treatment (step 3). For example, the composition can be treated at about 63° C. or greater for about 30 minutes or more. In step 4, the milk is transferred to a separator, e.g., a centrifuge, to separate the cream from the skim. The skim can be transferred into a second processing tank where it remains at about 2 to 8° C. until a filtration step (step 5).

Optionally, the cream separated from the skim in step 4, can undergo separation again to yield more skim.

Following separation of cream and skim (step 4), a desired amount of cream is added to the skim, and the composition undergoes further filtration (step 5), e.g., ultrafiltration. This process concentrates the nutrients in the skim milk by filtering out the water. The water obtained during the concentration is referred to as the permeate. Filters used during the ultrafiltration can be postwashed and the resulting solution added to the skim to maximize the amount of nutrients obtained. The skim is then blended with the cream (step 6) and samples taken for analysis. At this point during the process, the composition generally contains: about 8.5% to 9.5% of fat; about 3.5% to about 4.3% of protein; and about 8% to 10.5% of carbohydrates, e.g., lactose.

After the separation of cream and skim in step 4, the cream flows into a holding tank, e.g., a stainless steel container. The cream can be analyzed for its caloric, protein and fat content. When the nutritional content of cream is known, a portion of the cream can be added to the skim milk that has undergone filtration, e.g., ultrafiltration, (step 5) to achieve the caloric, protein and fat content required for the specific product being made. Minerals can be added to the milk prior to pasteurization.

At this point, the processed composition can be frozen prior to the addition of minerals and thawed at a later point for further processing. Any extra cream that was not used can also be stored, e.g., frozen. Optionally, before the processed composition is frozen, samples are taken for mineral analysis. Once the mineral content of the processed milk is known, the composition can be thawed (if it were frozen) and a desired amount of minerals can be added to achieve target values.

After step 6 and/or the optional freezing and/or mineral addition, the composition undergoes pasteurization (step 7). For example, the composition can be placed in a process tank that is connected to the high-temperature, short-time (HTST) pasteurizer via platinum-cured silastic tubing. After pasteurization, the milk can be collected into a second process tank and cooled. Other methods of pasteurization known in the art can be used. For example, in vat pasteurization the milk in the tank is heated to a minimum of 63° C. and held at that temperature for a minimum of thirty minutes. The air above the milk is steam heated to at least three degrees Celsius above the milk temperature. In one embodiment, the product temperature is about 66° C. or greater, the air temperature above the product is about 69° C. or greater, and the product is pasteurized for about 30 minutes or longer. In another embodiment, both HTST and vat pasteurization are performed.

The resulting high fat standardized human milk composition is generally processed aseptically. After cooling to about 2 to 8° C., the product is filled into containers of desired volumes, and various samples of the fortifier are taken for nutritional and bioburden analysis. The nutritional analysis ensures proper content of the composition. A label that reflects the nutritional analysis is generated for each container. The bioburden analysis tests for presence of contaminants, e.g., total aerobic count, B. cereus, E. coli, Coliform, Pseudomonas, Salmonella, Staphylococcus, yeast, and/or mold. Bioburden testing can be genetic testing.

### Example 3

### Use of Human Milk Cream Product for Extremely Premature Infants Results in Shorter Length of Hospital Stay

In a multi-center trial, infants were fed an exclusive human milk diet according to the investigative site's standard feeding protocol. This diet included mother's own milk or pasteurized donor human milk fortified with pasteurized donor HM-derived fortifier, Prolact+H²MF (Prolacta Bioscience, Industry, California). After informed consent was obtained, infants were randomized into two groups via blocks for four, the size of which was blinded. Masking of the study groups was only able to be attained at one of the study sites due to logistical reasons.

Once the infants began tolerating fortified enteral feeds (at approximately 100 cc/kg/d), milk analysis with a near infrared milk analyzer (Spectrastar 2400RTW; Unity Scientific, Brookfield Conn.) began. The base milk supply of infants in the control group was not analyzed in accordance with the standard practice at the investigative sites. Infants randomized to the cream group were supplemented with cream whenever their mother's own milk or donor human milk was found to be below 20 kcal/oz. Cream was added via the procedure outlined by Hair et al (Hair, A. B., et al., Randomized Trial of Human Milk Cream as a Supplement to Standard Fortification of an Exclusive Human Milk-Based Diet in Infants 750-1250 g Birth Weight. The Journal of pediatrics, 2014. 165(5): p. 915-920).

Neonatal demographic characteristics and clinical courses were obtained from the medical record. Outcome variables recorded included medically (indomethacin or ibuprofen course) or surgically managed patent ductus arteriosus (PDA), blood culture proven sepsis, necrotizing enterocolitis (defined as stage 2 NEC or greater by the modified Bell Criteria (Walsh 1986)), BPD (characterized by the need for oxygen therapy at 36 weeks post menstrual age (PMA) to maintain an adequate range of oxygen saturation), mortality, length of stay, PMA at discharge, and growth parameters (weight, length, and head circumference). All growth parameters were plotted on the Olsen curve (Olsen I E, Groveman S A, Lawson L, Clark R H, Zemel B S. New Intrauterine Growth Curves Based on United States Data. Pediatrics 2010: 125; e214) to obtain growth percentiles.

Infants that developed BPD were selected for a subgroup analysis due to the specific nutritional needs of this population. A comparison of the Control infants with BPD to the intervention group with BPD was performed.

A univariate statistical analysis was performed using the Wilcoxon rank-sum test for quantitative data and Fisher's exact test or its multinomial equivalent for categorical data. The categorical clinical outcomes of infants in the Cream vs Control group were analyzed using the chi square test for homogeneity. The analyses for LOS and PMA at discharge utilized a linear model that controlled for gestational age, birth weight and the presence of BPD along with the interaction of BPD and cream use as the main effects of the study group and BPD could have had a nonlinear component represented by the multiplicative interaction of the two.

A total of 78 infants weighing between 750 and 1250 g at birth were randomized in the trial; three of these infants were excluded from analysis (one due to sepsis and a subsequent bowel obstruction prior to the start of milk analysis, one due to clinically significant congenital heart disease and a chromosomal abnormality, and one due to intestinal perforation prior to the start of fortified feeds). Thus, 75 infants (Control n=37, Cream n=38) were included in the analysis after exclusion criteria was applied.

There were no significant differences in the infant characteristics of the Control and Cream intervention groups at the time of study enrollment (Table 2). Twenty one infants with BPD were also evaluated in a subgroup analysis. The subgroup of infants with BPD did not exhibit any significant difference in baseline characteristics (Table 3).

TABLE 2
Infant Demographics and Characteristics (Mean ± SD)

| | Control group | Cream group | P- |
|---|---|---|---|
| | n = 37 | n = 38 | value |
| Birth weight, g | 973 ± 152 | 973 ± 140 | 0.996 |
| Gestational age, weeks | 27.7 ± 2.0 | 27.7 ± 1.6 | 0.93 |
| Gender, % male | 56.8% | 47.4% | 0.42 |
| Race, % | 46.0/27.0/21.6/5.4% | 23.7/50.0/18.4/7.9% | 0.14 |
| Hispanic/Black/ | | | |
| White/Other | | | |
| APGAR at 5 minutes | 7.2 ± 1.5 | 6.8 ± 2.2 | 0.39 |
| Mechanical | 18.9% | 15.8% | 0.72 |
| ventilation, % | | | |
| Antenatal steroids, % | 81.1% | 79.0% | 0.82 |

TABLE 3
BPD Subgroup Demographics

| | Control Group With | Cream Group With | |
|---|---|---|---|
| | BPD | BPD | p- |
| | n = 12 | n = 9 | value |
| Birth weight, g | 949 ± 145* | 855 ± 104 | 0.12 |
| Gestational age, weeks | 27.0 ± 1.7 | 26.7 ± 1.4 | 0.60 |
| Gender, % male | 66.7% | 44.4% | 0.40 |
| Race, % | 33.3/16.7/41.7/8.3 | 33.3/22.2/22.2/22.2 | 0.77 |
| Hispanic/White/ | | | |
| Black/Other | | | |
| APGAR at 5 minutes | 7 ± 2^{†} | 7 ± 3 | 0.40 |
| Mechanical | 41.7% | 33.3% | 1.0 |
| ventilation, % | | | |
| Antenatal steroids, % | 91.7% | 66.7% | 0.27 |

Note:
all analyses of categorical data in this table used Fisher's exact test or its multinomial equivalent.

The clinical outcomes are listed in Table 4. These outcomes were notable for a trend towards a shorter length of stay (LOS) in the Cream group (74±22 days) as compared to the control group (86±39 days) with a p-value of 0.05 after employing the linear adjustment model described above. This trend was also noted in PMA at discharge with infants that received cream having a PMA at discharge that was an average of 1.7 weeks earlier than those who did not receive cream (38.2±2.7 weeks for the cream group and 39.9±4.8 weeks for control group, p=0.03, again using the linear adjustment model). Similarly, there was a trend toward increased weigh gain, increased growth in length as well as increase in head circumference in the in the Cream group compared to the Control group (Weight gain: 12.4 g/kg/day±3.9 for control group and 14.0 g/kg/day±2.5 for the Cream group; length 0.83 cm/week±0.41 for the Control group and 10.3 cm/week±0.33 for the Cream group; head circumference: 0.84 cm/week±0.22 for the Control group and 0.90 cm/week±0.19 for the Cream group). These outcomes were related to the presence of BPD (Table 5). Surprisingly, in this subset, infants receiving cream were noted to be discharged from the hospital an average of 17 days sooner than the Control group (LOS 104±23 days for the Cream group and 121±49 days for the Control group, p=0.08). Likewise, the PMA at discharge of infants with BPD that received cream was an average of 3.1 weeks earlier than the Control subjects with BPD (PMA at discharge 41.3±2.7 weeks for the Cream group and 44.2±6.1 weeks for the Control group, p=0.08).

TABLE 4
Clinical Outcomes of Study Infants

| | Control group | Cream Group | |
|---|---|---|---|
| | n = 37 | n = 38 | p-value |
| Mean (± SD) Energy | 20.3 ± 1.3 | 20.9± 2.1 | 0.08 |
| Content of Human Milk | (EBM*) | (EBM) | |
| (kcal/oz) | 21.8 ± 0.7 | 21.7 ± 0.5 | 0.54 |
| | (DM**) | (DM) | |
| Parenteral Nutrition (days) | 14.7 ± 9.0 | 17.7 ± 13.3 | 0.30 |
| (mean ± SD) | (median = 12) | (median = 12) | |
| Weight gain (g/kg/day) from | 12.4 ± 3.9 | 14.0 ± 2.5 | 0.03 |
| start of study to discharge | | | |
| (mean ± SD) | | | |
| Length (cm/week) (mean ± | 0.83 ± 0.41 | 1.03 ± 0.33 | 0.02 |
| SD) | | | |
| Head Circumference | 0.84 ± 0.22 | 0.90 ± 0.19 | 0.21 |
| (cm/week) | | | |
| (mean ± SD) | | | |
| PDA Ligation (%) | 8.1 | 2.6 | 0.36 |
| PDA treated with Indocin or | 27.0 | 29.0 | 0.85 |
| Ibuprofen (%) | | | |
| Sepsis (%) | 5.4 | 7.9 | 1.0 |
| Necrotizing Enterocolitis | 0 | 0 | — |
| (%) | | | |
| Bronchopulmonary | 32.4 | 23.7 | 0.40 |
| Dysplasia (%) | | | |
| Death (%) | 0% | 0% | — |
| Length of Stay (days) | 86 ± 39 | 74 ± 22 | 0.171 |
| | | | (0.05 |
| | | | using |
| | | | linear |
| | | | model |
| | | | 3) |
| PMA at Discharge (weeks) | 39.9 ± 4.8 | 38.2 ± 2.7 | 0.072 |
| | | | (0.03 |
| | | | using |
| | | | linear |
| | | | model |
| | | | 3) |

TABLE 5
Clinical Outcomes of Infants with BPD

| | Control Group | Cream Group | |
|---|---|---|---|
| | With BPD | With BPD | |
| | n = 12 | N = 9 | p-value |
| Mean (± SD) Energy Content of | 20.0 ± 0.8 | 20.9 ± 3.4 | 0.30 |
| Human Milk (kcal/oz) | (EBM*) | (EBM) | 0.39 |
| | 21.3 ± 0.2 | 21.7 ± 0.6 | |
| | (DM**) | (DM) | |
| Parenteral Nutrition (days) | 16.8 ± 7.6 | 25.2 ± 15.9 | 0.20 |
| (mean ± SD) | (median = 16.5) | (median = 22) | |
| Weight gain (g/kg/day) from | 12.6 ± 3.6 | 13.7 ± 2.3 | 0.40 |
| start of study to discharge (mean ± | | | |
| SD) | | | |
| Length (cm/week) (mean ± SD) | 0.76 ± 0.59 | 1.05 ± 0.16 | 0.18 |
| Head Circumference (cm/week) | 0.81 ± 0.16 | 0.90 ± 0.14 | 0.20 |
| (mean ± SD) | | | |
| PDA Ligation (%) | 16.7 | 11.1 | 1.0 |
| PDA treated with Indocin or | 41.7 | 66.7 | 0.29 |
| Ibuprofen (%) | | | |
| Sepsis (%) | 16.7 | 11.1 | 1.0 |
| Necrotizing Enterocolitis (%) | 0 | 0 | — |
| Death (%) | 0 | 0 | — |
| Length of Stay (days) | 121 ± 49 | 104 ± 23 | 0.32 (0.08 using linear |
| | | | model) |
| PMA at Discharge (weeks) | 44.2 ± 6.1 | 41.3 ± 2.7 | 0.14 (0.08 using linear |
| | | | model) |

No significant difference was noted in the rates of sepsis or PDA requiring intervention between the two groups. Likewise, the percentage of infants noted to be small for gestational age (<10^{th} percentile on the Olsen Curve) at 36 weeks did not significantly differ between the control and intervention group. Of note, there were no recorded deaths or episodes of necrotizing enterocolitis in this study.

It was found that preterm infants who received the novel human milk-derived cream supplement as an adjuvant to the standard fortification regimen had a shorter LOS and earlier PMA at discharge when compared to those who did not receive the cream supplement. Strikingly, infants with BPD who received the cream supplement also had significantly shorter LOS and earlier PMA at discharge compared to their BPD counterparts who did not receive the cream supplement.

The earlier discharge of the infants in the Cream group can have multiple clinical indications for this population. Cost containment exists as the most apparent benefit. By analyzing the 2001 Nationwide Inpatient Sample from the Healthcare Cost and Utilization Project, Russell et al (Russell R B, et al. Cost of Hospitalization for Preterm and Low Birth Weight Infants in the United States. Pediatrics 2007; 120: e1-e9.) found that while a diagnosis of prematurity or low birth weight represented only 8% of infant hospitalizations these diagnoses accounted for 47% of the costs (approximately 5.8 billion dollars). Of common comorbidities of prematurity, BPD has been shown to be associated with the highest amount of illness related costs, with expenses reaching 2.3 times the amount required to care for a gestational age matched infant without BPD (Johnson T J, Patel Al, Jegier B J, Engstrom J L, Meier P P. Cost of morbidities in very low birth weight infants. J Pediatr 2013; 162: 243-9).

The specific benefit noted for the subset of infants with BPD may be attributed to the vital role that adequate nutrition plays in lung growth and development (Jobe A H. Let's feed the preterm lung. J Pediatr (Rio J) 2006; 82(3):165-6; Wemhoner A. et al. Nutrition of preterm infants in relation to bronchopulmonary dysplasia. BMC Pulmonary Medicine 2011; 11:7). Multiple animal models have demonstrated malnutrition's adverse effect on lung structure. Mataloun et al showed that caloric restriction of 30% significantly reduced alveolar number and collagen deposition in the lungs of preterm rabbits (Mataloun M M, Rebello C M, Mascaretti R S, Dohlnikoff M, Leone C R. Pulmonary responses to nutritional restriction and hyperoxia in premature rabbits. J Pediatr (Rio J) 2006; 82:179-85). Likewise, when Massaro et al restricted the intake of adult rats, alveolar number decreased by 55% and alveolar surface area was reduced by 5% (Massaro G D et al. Lung alveoli: endogenous programmed destruction and regeneration. Am J Physiol Lung Cell Mol Physiol 2002; 283: L305-9.). These changes have been corroborated in human models of starvation such as emphysematous changes noted in the prisoners of the Warsaw Ghetto in World War II on autopsy (Massaro D, Massaro G D. Hunger Disease and Pulmonary Alveoli. Am J Respir Crit Care Med 2004; 170:723-4) and young women with anorexia nervosa on CT scan (Coxson H O et al. Early Emphysema in Patients with Anorexia Nervosa. Am J Respir Crit Care Med 2004; 170:748-752). Thus, the decreased caloric intake of the control subjects in our study may have interfered with their ability to continue lung development in the post-natal period. This undernutrition may have in turn diminished pulmonary function (Binwale and Ehrenkranz, 2006) creating further complications that prolonged their hospitalization.

The increased human milk fat and lipid content provided in the intervention group's feeds may have also positively impacted those with BPD. Increased fat content improves the bioavailability of fat soluble vitamins (Binwale and Ehrenkranz, 2006) such as Vitamin A which has independently been shown to reduce the incidence of BPD (Ehrenkranz 2014; Atkinson S A. Special Nutritional Needs of Infants for Prevention of and Recovery from Bronchopulmonary Dysplasia. J Nutr 2001; 131:942S-46S). Delivering additional lipids to meet the increased caloric needs of infants with BPD (Binwale and Ehrenkranz, 2006 and Theile et al, 2012) may also be advantageous as the metabolism of fat produces less carbon dioxide than that of carbohydrates (Binwale and Ehrenkranz, 2006). Moreover, specific lipids found in human milk may have assisted in producing an overall clinical benefit. For example, inositol is a phospholipid occurring in human milk suggested to promote the synthesis and secretion of pulmonary surfactant (Atkinson, 2001). Rudiger et al (Rudiger M, et al. Preterm infants with high polyunsaturated fatty acid and plasmalogen content in tracheal aspirates develop bronchopulmonary dysplasia less often. Pediatr Crit Care Med. 2000; 28: 1572-77) also demonstrated the premature infants with high concentrations of polyunsaturated fatty acids in tracheal aspirates were less likely to develop BPD.

Furthermore, this cream formulation, at 2.5 kcal/mL, allows for a substantial amount of calories to be added without a considerable increase in total feeding volume. Fluid restriction is especially important in the management of VLBW infants due to their predisposition to developing pulmonary edema (Biniwale and Ehrenkranz, 2006). Correspondingly, higher fluid intake and less weight loss in the first ten days of life has been demonstrated to increase an infant's risk of developing BPD (Oh W, et al. Association Between Fluid Intake and Weight Loss during the First Ten Days of Life and Risk of Bronchopulmonary Dysplasia in Extremely Low Birth Weight Infants. J Pediatr 2005; 147: 786-90.). In fact, Wemhoner et al (Wemhoner et al 2011) found that all infants in their study that received greater than the recommended 1840 mL/kg of fluid in the first 14 days of life went on to develop BPD. It has been postulated that higher fluid intake inhibits the process of extracellular fluid contraction after birth resulting in decreased lung compliance and need for higher ventilatory support that may damage the lung tissue and cause disease (Oh et al 2005). Thus, improvement in mechanisms to provide safe calorie dense feeds is of upmost importance to this population. Further research into the effectiveness of this and other calorie dense products in reducing fluid intake and the subsequent development of co-morbidities should be undertaken.

Taken together, infants receiving the cream supplement of the current invention had a shorter length of hospital stay and earlier PMA at discharge. This trend seemed to especially impact the subset of infants with BPD. This finding has large implications in decreasing healthcare costs, improving individual fortification strategies, and enhancing overall nutrition of premature infants. Proper nutrition can be obtained using an exclusive human milk diet with the addition of a cream supplement or from using the standardized high fat human milk formulations.

What is claimed is:

1. A method for improving one or more clinical outcomes in an infant with bronchopulmonary dysplasia (BPD) or at risk of developing BPD, comprising administering to said infant a human milk composition fortified with a pasteurized human milk cream composition, wherein the pasteurized human milk cream composition comprises about 2.0 kcal/ml to about 3.0 kcal/ml.

2. The method of claim 1, wherein the pasteurized human milk cream composition comprises about 25% fat.

3. The method of claim 1, wherein the pasteurized human milk cream composition further comprises permeate.

4. The method of claim 3 wherein the permeate is concentrated.

5. The method of claim 3 wherein the permeate is diluted.

6. The method of claim 1, wherein the pasteurized human milk cream composition further comprises deionized water.

7. The method of claim 1 wherein the pasteurized human milk cream composition comprises about 2.5 kcal/ml.

8. The method of claim 1 wherein the human milk composition fortified with a pasteurized human milk cream composition is the infant's mother.

9. The method of claim 1 wherein the human milk composition fortified with a pasteurized human milk cream composition is donor milk.

10. The method of claim 1 wherein the human milk composition fortified with a pasteurized human milk cream composition is a standardized human milk composition.

11. The method of any one of claim 8, 9 or 10 wherein the human milk composition fortified with a pasteurized human milk cream composition is also fortified with a protein-containing fortifier.

12. The method of claim 11 wherein the protein-containing fortifier is Prolact⁺™.

13. The method of claim 1, wherein the human milk composition fortified with a pasteurized human milk cream composition is administered enterally.

14. The method of claim 1, wherein the improved clinical outcome is a shorter length of stay in a hospital.

15. The method of claim 14, wherein the length of stay is about 5 days shorter.

16. The method of claim 14, wherein the length of stay is about 10 days shorter.

17. The method of claim 14, wherein the length of stay is about 15 days shorter.

18. The method of claim 14, wherein the length of stay is about 20 days shorter.

19. The method of claim 1, wherein the improved clinical outcome is an earlier post menstrual age at discharge from a hospital.

20. The method of claim 19, wherein the post menstrual age at discharge is about 1 week earlier.

21. The method of claim 19, wherein the post menstrual age at discharge is about 3 weeks earlier.

22. The method of claim 19, wherein the post menstrual age at discharge is about 6 weeks earlier.

23. A method for improving one or more clinical outcomes in a low birth weight infant, comprising administering to said low birth weight infant a standardized high fat human milk composition comprising a protein to energy ratio of about 1.5 g/100 kcal to about 3.0 g/100 kcal.

24. The method of claim 23, wherein the standardized high fat human milk composition comprises a protein to energy ratio of about 1.8 g/100 kcal to about 2.8 g/100 kcal.

25. The method of claim 23, wherein the standardized high fat human milk composition is administered enterally.

26. The method of claim 23, wherein the improved clinical outcome is a shorter length of stay in a hospital.

27. The method of claim 26, wherein the length of stay is about 5 days shorter.

28. The method of claim 26, wherein the length of stay is about 10 days shorter.

29. The method of claim 26, wherein the length of stay is about 15 days shorter.

30. The method of claim 26, wherein the length of stay is about 20 days shorter.

31. The method of claim 23, wherein the improved clinical outcome is an earlier post menstrual age at discharge from a hospital.

32. The method of claim 31, wherein the post menstrual age at discharge is about 1 week earlier.

33. The method of claim 31, wherein the post menstrual age at discharge is about 3 weeks earlier.

34. The method of claim 31, wherein the post menstrual age at discharge is about 6 weeks earlier.

35. The method of claim 23 wherein the improved clinical outcome is an increase in body length, an increase in body weight and/or an increase in head circumference.

36. The method of claim 23 wherein the low birth weight infant is a very low birth weight infant.

37. The method of claim 23 wherein the low birth weight infant has BPD or is at risk of developing BPD.

38. A standardized high fat human milk composition comprising an energy ratio of about 1.5 g/100 kcal to about 3.0 g/100 kcal.

39. The standardized high fat human milk composition of claim 38 comprising a protein to energy ratio of about 1.8 g/100 kcal.

40. The standardized high fat human milk composition of claim 39 comprising about 38 Cal/oz.

41. The standardized high fat human milk composition of claim 39 comprising about 23 mg/mL human milk protein and about 97 mg/mL human milk fat.

42. The standardized high fat human milk composition of claim 38 comprising a protein to energy ratio of about 2.34 g/100 kcal.

43. The standardized high fat human milk composition of claim 42 comprising about 38 Cal/oz.

44. The standardized high fat human milk composition of claim 42 comprising about 30 mg/mL human milk protein and about 94 mg/mL human milk fat.

45. The standardized high fat human milk composition of claim 38 comprising a protein to energy ratio of about 2.16 g/100 kcal.

46. The standardized high fat human milk composition of claim 45 comprising about 32 Cal/oz.

47. The standardized high fat human milk composition of claim 45 comprising about 23 mg/mL human milk protein and about 74 mg/mL human milk fat.

48. The standardized high fat human milk composition of claim 38 comprising a protein to energy ratio of about 2.77 g/100 kcal.

49. The standardized high fat human milk composition of claim 48 comprising about 32 Cal/oz.

50. The standardized high fat human milk composition of claim 48 comprising about 30 mg/mL of human milk protein and about 71 mg/mL of human milk fat.
